(19) United States
(12) Patent Application Publication
(10) Pub. No.: US 2019/0089785 A1
(43) Pub. Date: Mar. 21, 2019

(54) IDENTIFICATION ENCODING DEVICE AND IDENTIFICATION DECODING DEVICE FOR DATA DISTRIBUTION AND NETWORKS, AND NETWORK ELEMENTS COMPRISING SUCH DEVICES

(71) Applicant: Cadami GmbH, Eching (DE)

(72) Inventors: Andreas DOTZLER, München (DE); Michael HEINDLMAIER, Freising (DE); Maximilian RIEMENSBERGER, Eching (DE)

(73) Assignee: Cadami GmbH, Eching (DE)

(21) Appl. No.: 16/081,877

(22) PCT Filed: Mar. 3, 2017
(86) PCT No.: PCT/EP2017/055092

§ 371 Date: Aug. 31, 2018

(30) Foreign Application Priority Data
Mar. 3, 2016 (DE) 10 2016 103 880.6
Mar. 3, 2016 (DE) 10 2016 103 882.2
Apr. 29, 2016 (DE) 10 2016 108 018.7

(51) Int. Cl. H04L 29/08; G06F 16/172

(52) U.S. Cl. CPC H04L 67/1097; G06F 16/172; H04L 29/08729; H04L 67/2857

(57) ABSTRACT

An identification encoding device and devices for assigning an identifier to an element list for data distribution in a network, and an identification decoding device for assigning an element list to an identifier for data distribution in a network. Also, a cache allocation device, a group encoding device, a coordination device or a data block identification allocation device, are provided with an identification encoding device or an identification decoding device.

### CROSS-REFERENCE TO RELATED APPLICATIONS

This application claims benefit of priority to International Patent Application No. PCT/EP2017/055092, filed Mar. 3, 2017, and to German Patent Application No. 10 2016 103 880.6, filed Mar. 3, 2016, German Patent Application No. 10 2016 103 882.2, filed Mar. 3, 2016, and to German Patent Application No. 10 2016 108 018.7, filed Apr. 29, 2016, the entire contents of each are incorporated herein by reference.

### BACKGROUND

### Technical Field

The disclosure relates to an identification encoding device for assigning an identification to a list of elements for the purpose of data distribution in a network, wherein the list of elements has a plurality of elements selected from an element set, wherein each element is represented by a whole number and wherein the element set has a pre-determined total number of elements. Furthermore, the present disclosure relates to an identification decoding device for assigning a list of elements with an identification for the purpose of distribution of data in a network, wherein the identification is a whole number, wherein the list of elements to be determined has a plurality of elements selected from an element set, wherein each element is represented by a whole number and wherein the element set has a pre-determined total number of elements. Moreover, the present disclosure relates to a cache assigning device, a group encoding device, a coordinating device and a file system device, comprising at least one of an identification encoding device and an identification decoding device, respectively.

### Background Art

The distribution of large amounts of data to end user devices in package mediated networks, in particular mobile radio networks, currently happens mainly via so-called point-to-point connections. Each of the end user devices may start a connection via the network with a server, which has the data stored on it for this purpose. This can be done, for example, using TCP/IP connections which allow downloading of files from the server. One requirement for such connections causes that the respective requested file must be transmitted in its entirety. In this case, the network is again encumbered by the data of the file for each end user device, whereby the required bandwidth is increased.

There are different solutions known for reducing the bandwidth for this type of data transmissions in the case that the large amounts of data are stored data, from which different end user devices are going to frequently request the same data. Thus it is possible, for example, in times in which the network has little usage to transmit the requested elements of the stored data to the end user devices as a precaution. The end user devices store these elements, which are substantially files, data blocks or file fragments, in a cache memory.

If two end user devices request elements which are already held in the cache memory of the respective other end user device, the server may combine the two requested elements into a single data block having the length of a single element and transmit said data block as broadcast to all end user devices. The end user devices may subsequently use elements already in their cache memory to reconstruct the data from the data block transmitted in this manner. This device is also suitable to encode more than two data blocks together and thus allowing to consume only the bandwidth corresponding to about a single data block for transmitting a plurality of data blocks.

Examples for these methods are disclosed in US 2015/0207881 A1, US 2015/0207895 A1, US 2015/0207896 A1 and US 2012/0254459 A1. Furthermore, DE 10 2014 102 898 A1 discloses methods and devices for distributing large amounts of data. In order to allow identification of elements or data blocks in a cache memory of an end user device and/or of the end user devices which hold a particular element in their cache memory, said elements or end user devices are aggregated as sets or lists and uniquely identifiable sets of elements or lists of elements are assigned with identification, by which determining the elements to be combined is simplified. Large computational power for going through all possible associations or large amounts of memory for storing pre-calculated associations is necessary for the assigning operations connected with this.

The disclosure provides devices and methods which are able to perform the above-mentioned data distribution with fewer resources and are adapted to the particular needs of end user devices in mobile radio networks.

The disclosure thus provides identification encoding devices. These devices have the advantage vís-á-vís the known solutions that not all theoretically possible associations of identifications to lists of elements have to be combinatorically determined and verified. Moreover, the need for memory is limited to a few compact storable variables. Thus, both the computational power needed for implementing and using the devices and the need for memory is reduced.

Furthermore, the disclosure provides a cache assigning device, comprising an identification decoding device, by means of which a list of elements can be generated from a number of group identifications, an encoding parameter, a group identification, a data block identification and a file identification. The list of elements includes group identifications, whose end user devices are to cache a data block identifiable via data block identification. The cache assigning device advantageously comprises a decision device, configured to locate the group identification within the list of elements, wherein the cache assigning device is configured for generating cache storage signal, if the group identification is included within the list of elements and wherein the cache assigning device is configured for generating a non-cache storage signal, if the group identification is not included in the list of elements. The cache storage signal may instruct an end user device, for example, to record the data block in a cache memory and the non-cache storage signal may instruct an end user device, not to record the data block in the cache memory. An end user device which, for example, may be limited in its available resources, may determine more easily, whether the end user device shall intermediately store a transmitted data block, by means of the cache assigning device.

Furthermore the disclosure further provides a group encoding device for determining a list of jointly encodable requests from a list of waiting requests, wherein each request comprises at least a group identification and a data block identification, wherein the group encoding device comprises for the purpose of processing a selected request: an identification decoding device for determining a list of group identifications, in whose assigned cache memories the data block with the requested identification is held, a candidate determining device for determining a list of all group identifications and lists, which result from removing a group identification from the list and inserting the group identification of the selected request into the list; an identification encoding device for determining of group identifications and data block identifications from the list. The identification encoding device assigns each list from the list an identification, and a request selecting device for determining a list by means of combining the list and the list of waiting requests, that for each entry (i′, c′) of the list at most one entry of the list of the form (i, f, c) is selected for insertion into the list, such that i′=i and c′=c. Using this, in particular the determination of jointly encodable data blocks based on requested data blocks is possible in a resource friendly manner.

The disclosure further provides a communication device for transforming information about a jointly encoded data block into header data, wherein information about the data block, a list of group identifications, a list of file identifications as well as a system parameter are passed on to the communication device. The communication device comprises an identification encoding device for transforming the list of group identifications into an index, and a header data generating device for jointly transforming the index with the list of file identifications into header data. By transforming the list of group identifications into an index the amount of data to be transmitted via a network is reduced, thus the possible quota of user data in this network is improved.

In addition, the disclosure provides a file system device for assigning a local data block identification to a data block identification is suggested, having an identification decoding device for generating a list of group identifications which includes the groups holding the data block identification designating the data block, a mapping device for transforming the list and an identification encoding device for obtaining the local data block identification from the transformed list. The identification decoding device and/or the identification encoding device are particularly configured according to an embodiment described in here or previous.

Moreover, the disclosure provides a file system device for determining a data block identification associated with a local data block identification, having an identification decoding device for generating a list of group identifications, a mapping device for transforming the list and an identification encoding device for obtaining the data block identification from the transformed list. The identification decoding device and/or the identification encoding device are particularly configured according to an embodiment described in here or previous.

Furthermore, complementary methods are suggested. These methods have the advantage compared to the known solutions that not all possible associations have to be combinatoricly determined and verified. Moreover, the need for memory is limited to a few compactly storable variables. Thus, both the required computational power and the need for memory for performing the method is reduced.

Advantageously, instead of an individual calculation of the binominal coefficient a pre-calculated table of these coefficients is used. Thereby, the required computational power is further reduced, by accepting a small increase in the need for memory.

The disclosure further provides a network in which at least one end user device has an assigning device, configured for performing at least one of the above-mentioned methods. The disclosure also provides a network in which at least one server is connected to the network, the server having an assigning device configured for performing at least one of the above-mentioned methods.

### BRIEF DESCRIPTION OF THE DRAWINGS

The disclosure is subsequently described in more detail by means of drawings, which schematically depict the disclosure and do not limit the scope of protection.

Herein:

FIG. 1 depicts a flow diagram of a method for determining an identification associated with a list of elements according to a first embodiment of the disclosure;

FIG. 2 depicts a flow diagram of a method for determining a list of elements associated with an identification according to a first embodiment of the disclosure;

FIG. 3 depicts an overview of a network for distributing data to end user devices within the network;

FIG. 4 depicts an overview of end user devices and their memory devices within the network;

FIG. 5 depicts an overview of end user devices and their memory devices in further network;

FIG. 6 depicts a schematic configuration of a cache assigning device according to an embodiment of the present disclosure;

FIG. 7 depicts a schematic configuration of a group encoding device according to an embodiment of the present disclosure;

FIG. 8 depicts a schematic configuration of a coordinating device according to an embodiment of the disclosure;

FIG. 9 depicts a schematic configuration of a file system device according to an embodiment of the present disclosure; and

FIG. 10 depicts a schematic configuration of a file system device which is complement to the file system device according to FIG. 9.

### DETAILED DESCRIPTION

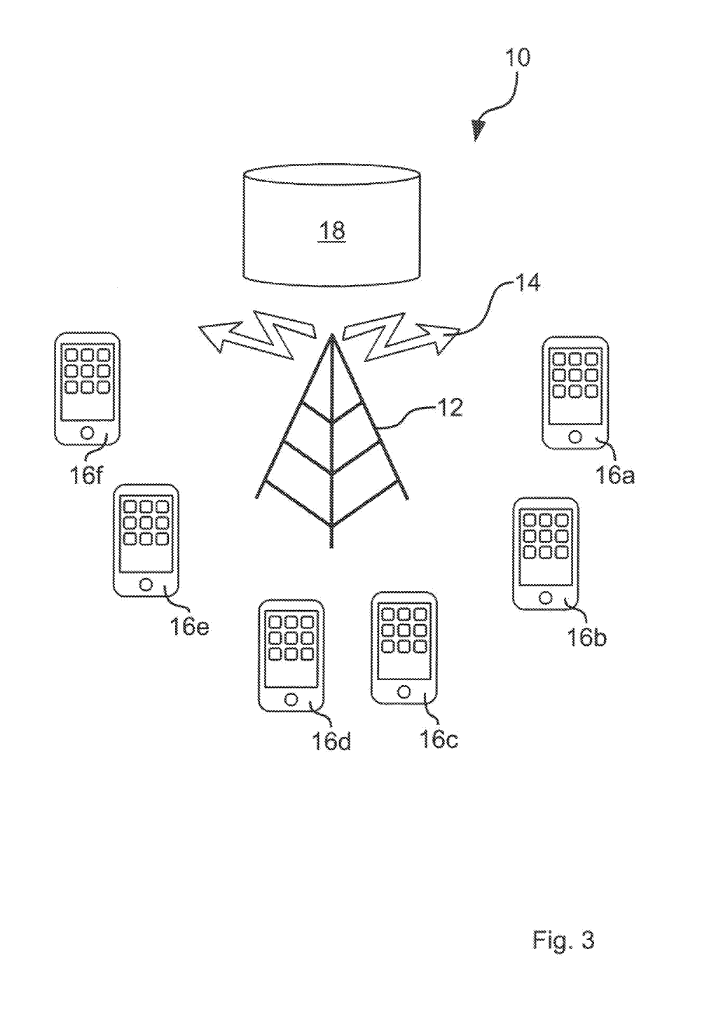

Network 10, depicted in FIG. 3, is configured as a mobile radio network, for example. The mobile radio network 10 comprises a base station 12 which communicates via a medium 14, for instance by electromagnetic waves, with a plurality of end user devices 16a-16f. A data providing device (server) 18 is connected to the network 10, the server 18 providing data for retrieval by the end user devices 16a-16f.

The end user devices 16a-16f may retrieve data from the data providing device 18 via mobile radio network 10 using the IP protocol, for example. These data are subsequently transmitted to the end user devices 16a-16f via mobile radio network 10. The medium 14 has a limited bandwidth, whereby the amount of data which can be transmitted per unit time is limited. In a wireless medium 14, the end user devices 16a-16f using the same, share the available bandwidth. Thereby, the transmission of data requested by one of the end user devices 16a-16f can be slowed down, if the end user devices 16a-16f request large amounts of data.

The amount of requested data in real existing mobile radio networks 10 is usually dependent on the time of day. Videos, for example, which comprise particular large amounts of data are frequently requested in the evening, so that mobile radio networks 10 are particularly congested at this time. In contrast, in the early hours of the morning, only small amounts of data are requested, so that the mobile radio network 10 provides large unused capacities at this point in time.

For these circumstances it arises that frequently requested data, for instance data of an online video library, are transmitted as a precaution at times, at which the occupancy of mobile radio network 10 is low so that a new transmission at times, in which the occupancy of the mobile radio network 10 is high, is not necessary. Usually the video libraries have so much data, that complete caching on mobile end user devices 16a-16f is not practical due to the limited size of the memory devices enclosed therein. Moreover, the bandwidths currently available in mobile radio networks 10 are not suitable for a regular precautionary transmission of these amounts of data.

In particular, in mobile radio networks 10 the medium 14 is configured in such a way that one and the same data may be sent to all end user devices 16a-16f simultaneously (broadcasting, broadcast), wherein the bandwidth for the transmission is only required once for all end user devices 16a-16f and not separately required again for all end user devices 16a-16f.

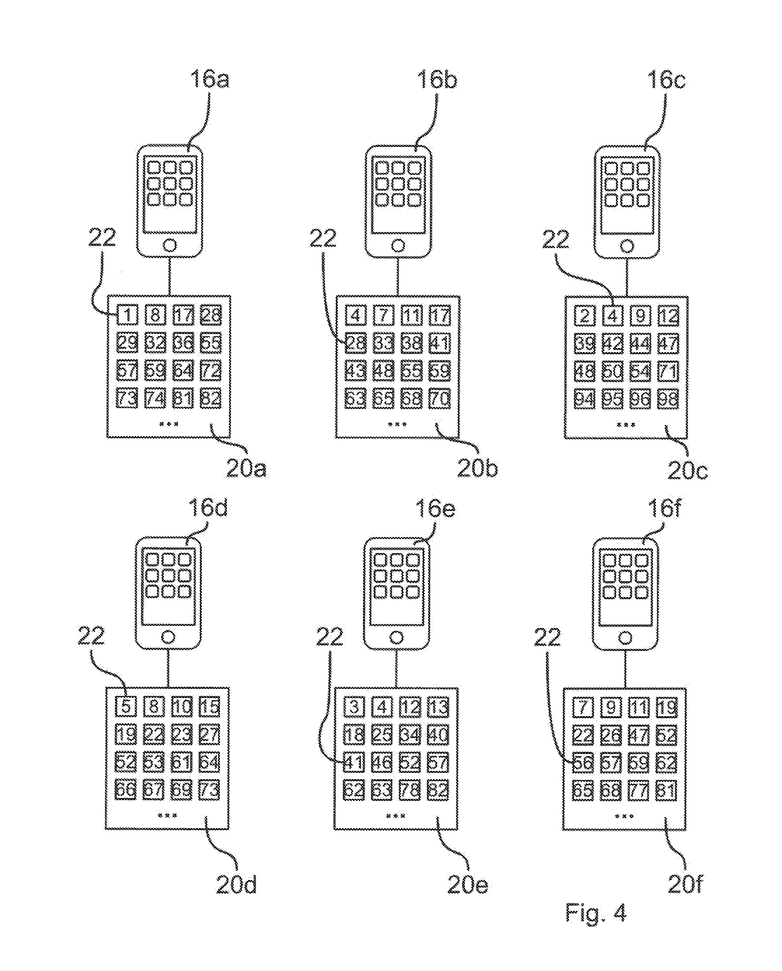

This is considered by applying so called index coding. This may be implemented on the end user devices 16a-16f, as depicted in FIG. 4. Each of the end user devices 16a-16f comprises a memory device 20a-20f, also called a cache memory, which is able to store data blocks 22. Each of the data blocks 22 may be part of a larger file, for example, a video file, or a self-contained file. Each of the data blocks 22 is thus an element of a total set of elements, which are stored in the data providing device 18. In order to uniquely identify the data blocks 22 each of the data blocks 22 or the elements, respectively, is assigned a whole number as data block identification c.

Within the memory device 20a of end user device 16a the data blocks 22 with data block identifications 1, 8, 17, 28 as well as some further ones are stored, for example. Within memory device 20b of end user device 16b the data blocks 22 with data block identifications 4, 7, 11, 17 as well as some further ones are stored, for example. Now, if end user device 16a requests the data block 22 with data block identification c=4 and if simultaneously end user device 16b requests the data block 22 with the data block identification c=1 the two data blocks 22 may be mathematically combined, for instance within the data providing device 18 by means of in particular an exclusive-or-operation (XOR). The resulting encoded data block 1+4 may be combined with data block 22 having the data block identification c=4 that the data block 22 having data block identification c=1 may be obtained. Furthermore, the data block 1+4 may be combined with the data block 22 having data block identification c=1 in such a way that the data block 22 having the data block identification c=4 is obtainable.

The data block 1+4 occupies the bandwidth of the medium 14 only once due to the possibility of broadcasting. Yet, both the end user device 16a and the end user device 16b have obtained the requested data. In this case the required bandwidth is reduced by half.

In order to apply this method, the data providing device 18 must obtain information about which data blocks 22 were stored in which end user devices 16a-16f and which combination of requests can be joined into combined data blocks. In order to efficiently transmit this information and process it, index coding encodes lists into indices. For example, a list having as elements all end user devices 16a-16f, which have cached a data block 22 with a particular data block identification c in their memory device 20a-20f, may be associated an index in form of an identification. This identification is thus uniquely assigned a list of elements. Thereby, end user devices 16a-16f, may, for example, be aggregated into groups, which are assigned a group identification i, respectively. The list or rather the identification may also represent other information, such as which data blocks 22 are stored in the memory device 20a-20f of a particular end user device 16a-16f.

The association between the list of elements (subset) and the identification (index) may be performed via counting according to the following method described in pseudo code:

subset = index_to_subset(index, N, K) {

count <− 1
for (i = 1:2\hat{ }N−1) {

set <− binary-to-set( number-to-binary(i) )
if (lsetl == K) { count<− count +1 }
if (count == index) { return set }

}

}
index = subset_to_index(subset, N, K) {

count <− 1
binary-subset <− set-to-binary(subset)
for (i = 1 :2\hat{ }N−1) {

set <− binary-to-set( number-to-binary(i) )
if (lsetl == K) {

count <− count +1
if ( binary-subset == number-to-binary(i) ) { return i }

}

}

}

With this method of assigning lists of elements to identifications, substantially all possible associations are tried until the correct association is found. This requires large computational power.

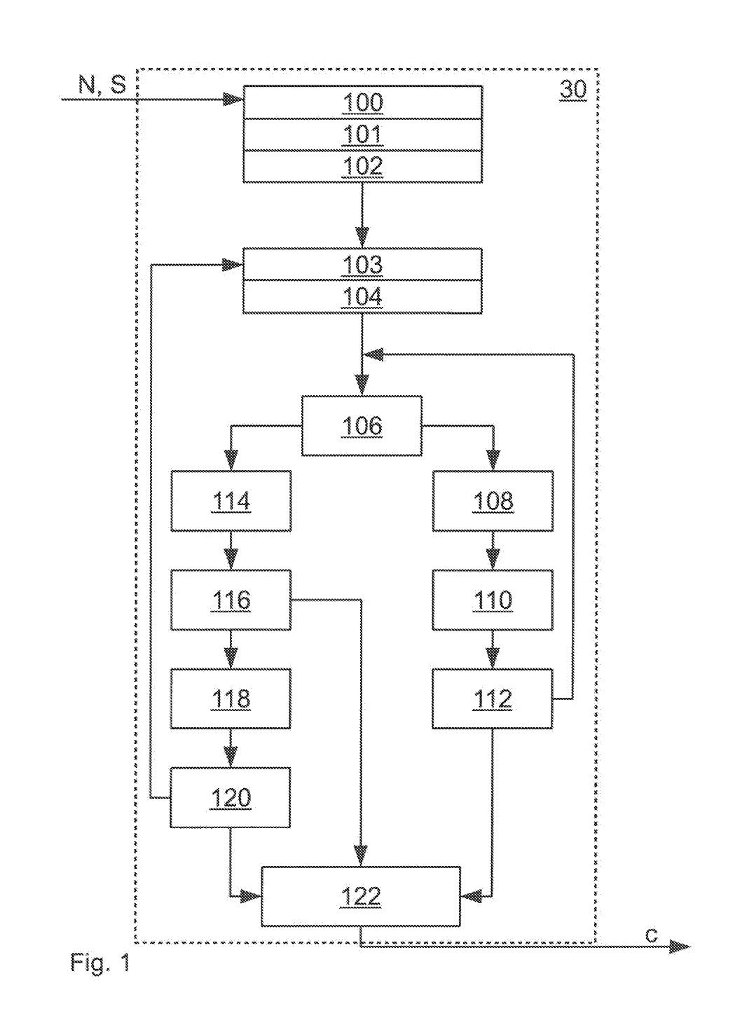

Alternatively, assigning the lists of elements to identifications may be calculated beforehand and subsequently stored as pre-calculated assignment. This requires lots of memory. Already with moderate amounts of end user devices 16a-16f and data blocks 22, over 50 Gigabytes of data arise for this pre-calculated assignment. Such large data structures are hardly kept available in mobile end user devices 16a-16f. The identification encoding device 30 depicted in FIG. 1 is configured for performing a method for assigning an identification to a known list of elements, as subsequently described. The identification encoding device 30 is given a list of elements S. The list of elements S includes a plurality of elements, wherein each element is represented by a whole number. The elements are taken from a set of elements, which represents all possible elements such as all data blocks 22. This set of elements has a pre-determined total number N of elements.

Starting from the list S of elements, initially a number of elements, which are included in the list S of elements, is determined in a first preparatory step 100. This number is usually called cardinality. The result is stored within a cardinality counter k. In a second preparatory step 101 the number 0 is stored in a limiting counter b. In a third preparatory step 102 the number 0 is stored in a buffer c.

The preparatory steps 100 to 102 may be executed in arbitrary sequence.

In a first step 103, the smallest element of the list of elements S is determined and stored in an element buffer m. The smallest element of the list of elements S which is stored in the element buffer m is removed from the list of elements S in a second step 104. In a third step 106, the value of the element buffer m and the limiting buffer b are compared. If the values are not identical, the method continues in the eighth step 108 described below.

In a fourth step 114, the cardinality counter k is decremented by one. In a subsequent fifth step 116 the value of the cardinality counter k is compared with 0. If the value of the cardinality counter k is equal to 0, the method continues with closing step 122 described below.

In a sixth step 118 the limiting counter b is incremented by one.

In a seventh step 120 it is determined, whether the limiting counter b corresponds to the total number N of elements. If this is the case, the method continues with closing step 122. If this not the case, the method continues with the first step 103.

In the eighth step 108 a binomial coefficient is calculated as follows

$$( \begin{matrix}N - b - 1 \\ k - 1\end{matrix} )$$

and added to the buffer c.

In a ninth step 110, limiting counter b is incremented by one. In a tenth step 112, the limiting counter b is compared with the total number N. If the values are identical, the method continues with closing step 122. Otherwise the method continues with the third step 106.

In the closing step 122, the content of buffer c is passed on. The content represents the determined identification and is output by the identification assigning device 30 as the identification c of the list of elements S. This identification may be a global/or a local data block identification c, which describes a data block 22 which is cached on the end user devices 16a-16f contained in the list of elements S.

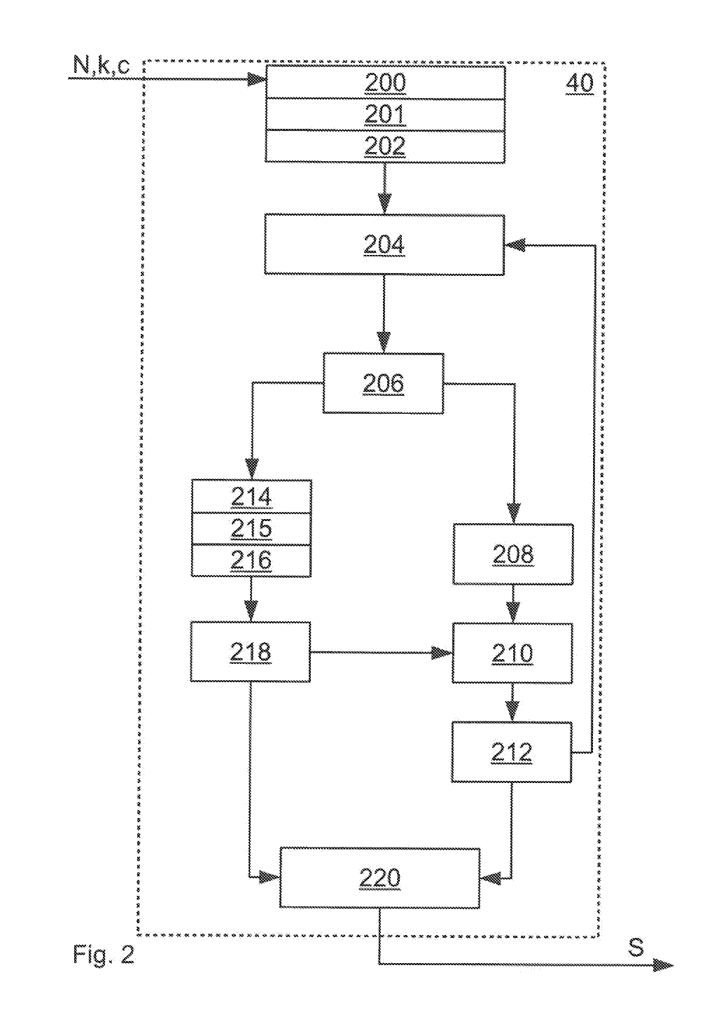

An identification decoding device 40, as depicted in FIG. 2, is configured for performing a method for assigning a list of elements S to a known identification, which is described below. The identification decoding device 40 is given an identification (for instance a data block identification c) in form of a whole number and stored in an identification buffer c. The list of elements S to be determined should have a pre-determined cardinality, which is stored in a cardinality counter k. Moreover, a set of elements, for which the elements of the list of elements S are to be selected, has a pre-determined total number N of elements.

In a first preparatory step 200, the number 0 is stored in a limiting counter b and, in a second preparatory step 201, 0 is stored in an element counter m. In a third preparatory step 202, an initially empty list is stored as a list of elements S.

The preparatory steps 200-202 may be performed in arbitrary sequence.

In a first step 204, a binomial coefficient

$$( \begin{matrix}N - b - 1 \\ k - 1\end{matrix} )$$

is calculated and stored in a buffer z.

In a second step 206, the value of the identification buffer c and the buffer z are compared with each other. If the identification buffer c has a value, which is greater than or equal to the value of buffer z, the method continues with a sixth step 214 described below.

In a third step 208, the value of the identification buffer c is decremented or reduced by the value of the buffer z.

In a fourth step 210, the limiting counter b is incremented by one.

In a fifth step 212, the value of limiting counter b is compared with the total number N. If the values are equal, the method continues with the first step 204, otherwise the method continues with closing step 220.

In closing step 220, the list of elements S is output by the identification decoding device 40 as a result.

In the sixth step 214 the value of the element counter m is added to the list of elements S.

In a seventh step 215, the element counter m is incremented by one.

In an eighth step 216, the cardinality counter k is decremented by one.

In a ninth step 218, the value of the cardinality counter k is compared with 0 and the method continues with closing step 220, if this is the case. Otherwise, the method continues with the fourth step 210.

The outputting of the result in steps 122, 220 may be achieved by passing on the result to a further processing device or by storing it in a memory portion.

Both methods 100-122, 200-220 are insofar complementary, as they are the inverse of each other.

The methods 100-122, 200-220 may be implemented as instructions to a computer, for example as program code, which causes the computer to perform the methods 100-122, 200-220. The methods 100-122, 200-220 are not necessarily executed in the same device. For example, the first method 100-122 may be executed in an identification encoding device 30 of an end user device 16a-16f or the second method 200-220 may be performed in an identification decoding device 40 of the data providing device 18, and vice versa. It is also conceivable that the methods 100-122, 200-220 for assigning different aspects of a distribution of data blocks 22 are executed in different devices of the network 10.

The instant network 10 comprises a single data providing device 18 and six end user devices 16a-16f. The methods 100-122, 200-220 and thus also the identification encoding device 30 and the identification decoding device 40 are not limited to these numbers. It is rather possible to have an arbitrary number of data providing devices 18 and an arbitrary number of end user devices 16a-16f in the network 10. The network 10 forms a data distribution system.

In the network 10, each user and each end user device 16a-16f, respectively, may request particular sections (data blocks) of files for delivery from the data providing device 18. The data providing device 18 may include a data library having a plurality of large files, for instance a video library or audio library. Each of the files is divided into data blocks (chunks) 22, which are assigned a data block identification (chunk id) c, respectively. Each of the data blocks 22 may be requested from each of the end user devices 16a-16f. Each end user device 16a-16f may have stored locally in its cache memory 20a-20f some or all data blocks 22 of some video, audio or data files. This means that these data blocks 22 are transmitted at a predetermined point in time as a precaution to the end user devices 16a-16f, since it is expected that they are needed at a later point in time.

For the purpose of choosing the data blocks 22 which are to be stored in the cache memory 20a-20f of each end user device 16a-16f, the data providing device 18 may comprise a selection device, which selects the data blocks 22 from the total set of available data blocks 22. This selection may be performed using a selection method.

The selection method may include a step, in which a random data block 22 is selected. In a further step, the end user device 16a-16f is transmitted the information that this data block 22 is to be recorded in the cache memory 20a-20f upon transmission. These steps are repeated until the cache memory 20a-20f of each end user device is full or it has a predetermined number of data blocks 22.

If the selection by means of such method is performed, it is useful to have a list within the data providing device 18, the list storing which end user device 16a-16f has cached which data block 22 in its respective cache memory 20a-20f. Thereby, it may be avoided that the list of the respective stored data blocks 22 is to be newly requested upon each transmission operation by the end user device 16a-16f.

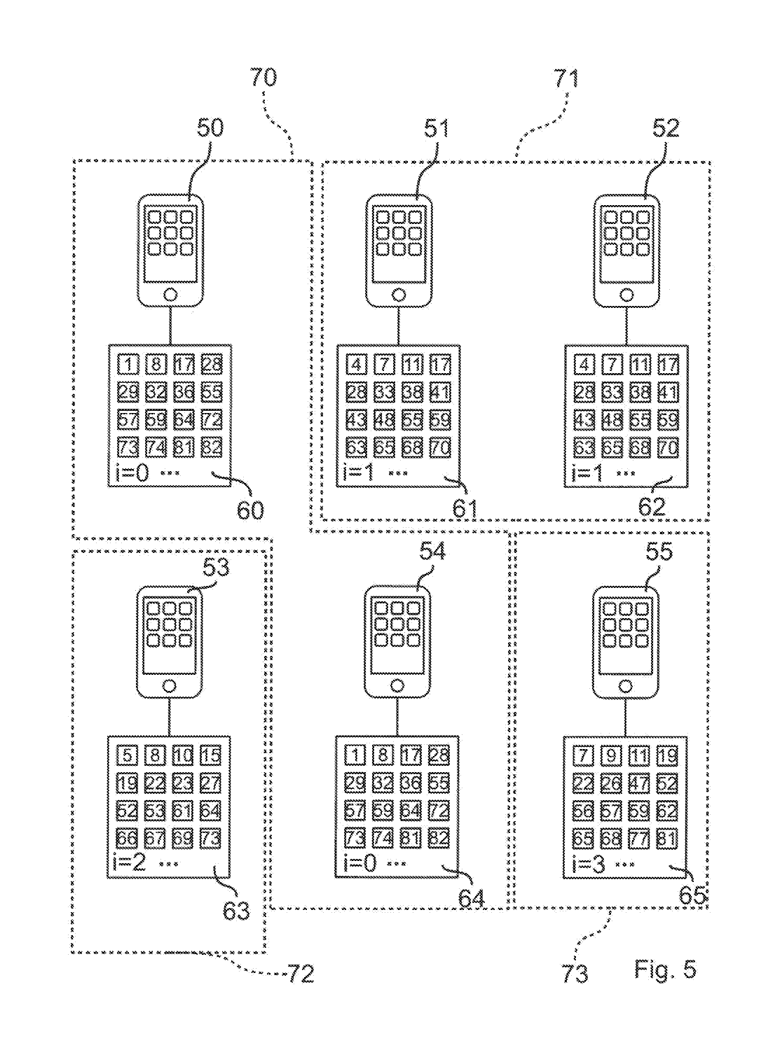

A further selection method (see FIG. 5) may comprise that initially a plurality of end user devices 50-55 having cache memories 60-65, which are similarly or identically configured like the end user devices 16a-16f with their cache memories 20a-20f, are aggregated into a group 70-73, wherein each of the groups 70-73 is assigned a group identification (user id) i. All end user devices 50-55, which are members of the same group 70-73, have the same data blocks 22 in their cache memory 60-65. Thus, the data providing device 18 does not have to store the complete state of the cache memory 60-65 for each end user device 50-55 anymore, but rather only the association of the respective end user device 50-55 to one of the groups 70-73.

The number of groups 70-73 to be formed is a system parameter N of the data distribution system. The group identification or user identifiers i are whole numbers, so that i∈{0, . . . , N−1}. Each of these group identifications define a cache state, i.e. a particular set of data blocks 22 to be held in the cache memory 60-65, wherein each data block 22 is uniquely identifiable by a file identifier f∈{0, . . . , F−1} and/or a data block identification c∈{0, . . . , C−1}.

A selectable system parameter kε{1, 2, . . . } influences, in how many groups 70-73 each file fragment 22 is held in the cache memory 60-65.

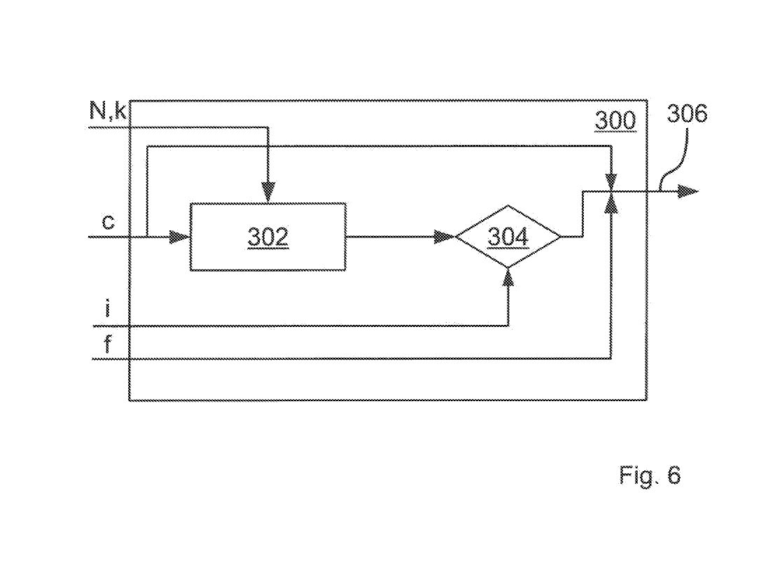

A cache assigning device 300, as depicted in FIG. 6, may be provided for the purpose for selecting the data blocks 22 to be stored in the cache memory 60-65. The cache assigning device 300 obtains the system parameter N and k, as well as a group identification i and a data block identification c as input parameters.

The cache assigning device 300 has an identification decoding device 302 configured for performing above-described method 200-220 for assigning a list of elements to an identification. The identification encoding device 302 processes input parameters N, k and c to a list S of group identifications of groups 70-73, in which data block 22 having data block identification c is to be held.

The list S is passed onto a decision device 304, which checks whether the group identification i, which was passed on to the cache assigning device 300 as an input parameter, is included in the list S. If the decision device 304 determines that the group identification i is contained in the list S, the decision device 304 generates an output signal 306 which indicates that the data block 22, which has the data block identification c, is stored or is to be stored by the end user devices 50-55 of the group having group identification i (cache signal). If the decision device 304 determines that the group identification i is not contained in the list S, the decision device 304 generates a signal, which indicates the opposite (non-cache signal, data block 22 is not stored).

The cache assigning device 300 may be part of the data providing device 18 or the end user device 50-55. In the providing device 18, the cache assigning device 300 serves to determine, whether a particular data block 22 has to be transmitted to a particular end user device 50-55 at all or is already kept available in this end user device 50-55. In an end user device 50-55, the cache assigning device 300 may serve to determine, whether a recorded data block 22 is to be added to the cache memory 60-65 or not.

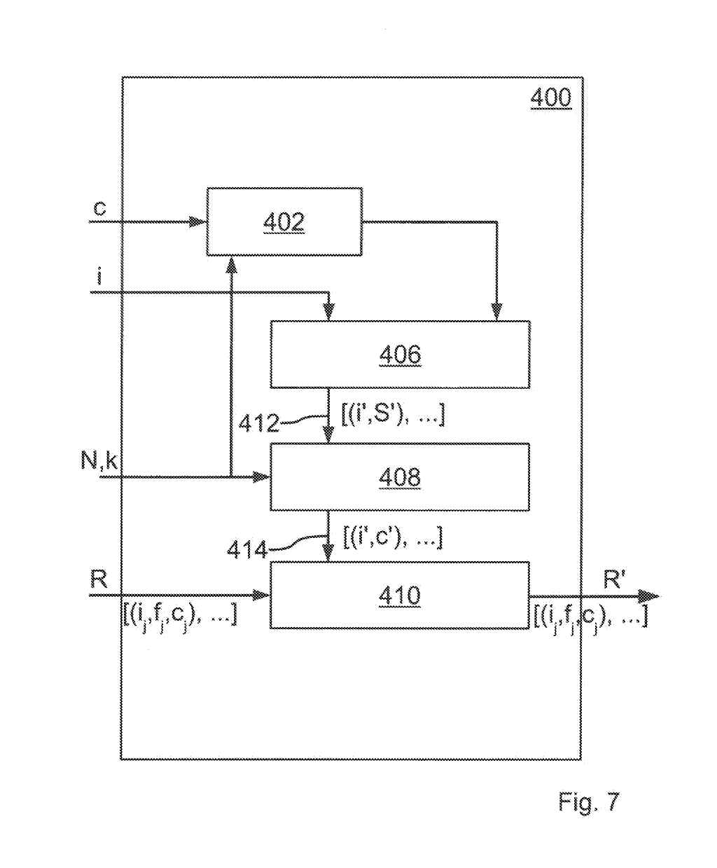

A group encoding device 400 performs the selection of jointly encodable data blocks 22 based on the requests of end user devices 50-55 and is depicted in FIG. 7. The group encoding device 400 has an identification decoding device 402, a candidate determining device 406, an identification encoding device 408 as well as a request selection device 410.

Initially, different requests sent by the end user devices 50-55 are collected by the data providing device 18. A request comprises, for example, the group identification i of the requesting end user device 50-55 as well as the data block identification c of the requested data block 22.

Additionally, a request may also include the file identification f of the requested file. The requests may be stored in a list R, for example. One of the requests is selected and from its data block identification c, a list S of the groups 70-73 with group identifications I is determined, in whose associated cache memory 60-65 the data block 22 with the data block identification c is held by means of the identification decoding device 402.

The list S is passed on to the candidate determining device 406. For each entry i′ in the list S the candidate determining device 406 determines a list of tuples (i′, S′), wherein S′ is obtained by removing the group identification i′ from S and instead inserting the group identification i of the selected request to S.

By means of identification encoding device 408, in each of the tuples determined in such manner, the list S′ is replaced by the identification encoding device 408 with data block identification c′, so that a list of tuples (i′, c′,) is generated which in turn is passed on to the request selection device 410.

The request selection device 410 selects, in response for each tuple (i′, c′), at most one request from the requests R, whose group identification i=i′ and whose data block identification c=c′, and stores these requests in a list R′. The requests R′ selected in this manner may be encoded for joint transmission.

After the group encoding device 400 has generated a list of jointly encodable data blocks 22, the corresponding data blocks 22 are collectively encoded into one encoded data block (not shown). For the purposes of transmission of the jointly encoded data block, header data are added thereto, the header data indicating which data block within the encoded data block are jointly encoded. This information is necessary so that the end user devices 50-55 may select the data blocks 22 from their cache memories 60-65 by means of which the jointly encoded data block may be decoded, thereby allowing the utilization of the data included therein.

For this purpose, a scheduling device or communication device 500 is provided. A simple communication device 500 may add a list of data block identifications c of jointly encoded data blocks 22 to each jointly encoded data block. In particular with encoded data blocks, in which many data blocks 22 are jointly encoded such a list may become disproportionately large, so that in addition to the user data lots of header data must be transmitted.

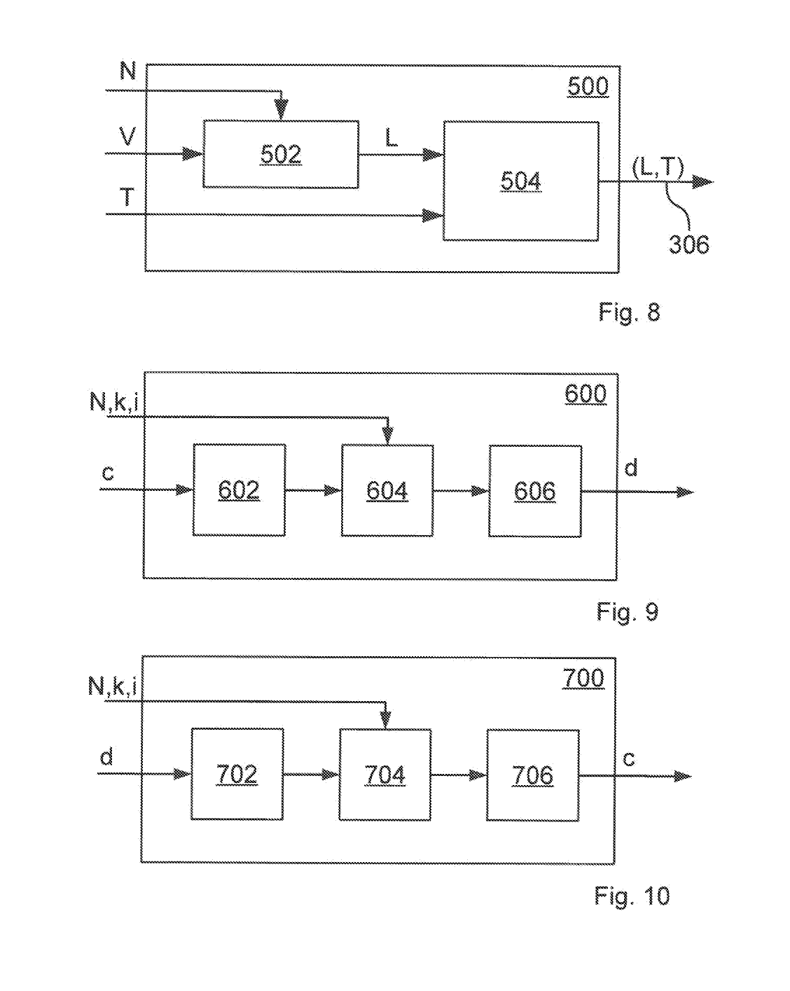

Due to the properties of the identification decoding device 302 in the cache assigning device 300, a communication device 500 as depicted in FIG. 8 may reduce the amount of header data to be transmitted. The communication device 500 comprises an identification encoding device 502, which is configured like the identification encoding device 30.

In addition to system parameter N, the communication device 500 is given a list V of group identifications i, in whose cache memories the data blocks 22 contained in the jointly encoded data block are held. Moreover, the communication device 500 is given a list T with file identifications f, which represent the files whose content was partially used for the joint encoding, respectively. The lists V and T have a length of k+1. The identification encoding device 502 processes the list V as well as parameters N and k+1 into an index L.

The index L is passed on to a header data generating device 504 together with the list T and the header data 506 generated by the header data generating device 504 is added to the jointly encoded data block. An end user device may retrieve the list V by inverting by means of an identification decoding device, thereby determining the data block identifications c of the data blocks which entered into the jointly encoded data block.

Within the list T of file identifications f particular values for file identifications f may designate, for example, that of this file no data block 22 was entered into the jointly encoded data block. This is in particular useful for designating, which data blocks 22 were not jointly encodable.

The cache memory 60-65 includes data blocks 22, which are selected due to the association of the end user device 50-55 to a group 70-73 with complete data library, respectively. In order to be able to identify the data blocks 22 stored in the cache memory 60-65 on the basis of the system wide assigned data block identification c, the data block identification c may be stored together with the data blocks 22, respectively.

In order to save space, the data blocks 22, which for example have a fixed length or section size G, may be stored in a linear sequence within the cache memory 60-65. The storage location within a linear storage medium may be determined from the data block identification c by means of formula G*c. Since only part of the data blocks 22 are stored in the cache memory 60-65, an assignment in this matter results in large unused portions of memory within the cache memory 60-65.

Thus, it may be preferred, to assign local data block identifications d to the system wide data block identifications c, which allow a compact arrangement or storage of the data blocks 22 in the cache memory 60-65. For this purpose, an end user device 50-55 may comprise a data block identification assigning device 600, which is given the system parameters N and k as well as the group identification i as input parameters.

The data block identification assigning device 600 comprises an identification decoding device 602, a mapping device 604 and an identification encoding device 606. The identification decoding device performs the method 200-220 for assigning a list of elements to an identification, so as to generate a list of group identifications i, in which the data blocks 22 with the data block identification c are held, from parameters N, k and c.

In a first embodiment the mapping device 604 takes over this list and executes the following steps: removing of the own group identification i from the list; decrementing all group identifications by one, if their absolute value is bigger than the own group identification i. The resulting list comprises one less element than the list generated by the identification encoding device 602.

The list generated by the mapping device 604 is passed on to the identification encoding device 606, which takes into account the system parameters N−1 and k−1 and generates the local data block identification d.

In a second embodiment the mapping device 604 takes over the list and executes the following steps: checking, whether group identification 0 is contained in the list; checking, whether the own group identification i is contained in the list; if the group identification 0 was contained in the list, removing the group identification 0 and adding the own group identification i; if the own group identification i was contained, removing the group identification i and adding the group identification 0; if both the group identification 0 and the group identification i were contained or neither the group identification 0 nor the group identification i were contained, no change.

The resulting list is passed on to the identification encoding device 606, which, taking into account system parameters N and k, generates the local data block identification d, for example, by applying method steps 100-122.

The second embodiment of the data block identification assigning device 600 allows assigning a local data block identification d to data blocks 22, which are not assigned to group identification i. The local data block identifications d of the data blocks 22, which are assigned to group identification i, are by virtue of this method always smaller than the local data block identifications d of the data blocks 22, which are not assigned to group identification i. Thus, it is possible, to store data blocks 22 which do not belong to group identification i, whereby the data blocks 22 belonging to the group identification i are still stored in a compact manner at the beginning of cache memory 60-65.

In a third embodiment the data block identification assigning device 600, the mapping device 604 takes over the list and executes the following steps: checking, whether the own group identification i is contained in the list; if the own group identification was not contained, incrementing all group identifications contained in the list by one, if their absolute values are smaller than the own group identification i; if the own group identification i was contained, removing the group identification i, incrementing all group identifications contained in the list by one, if their absolute value is smaller than the own group identification and adding group identification 0.

The resulting list is transferred to the identification encoding device 606, which, taking into account the system parameters N and k, generates the local data block identification d, for example, by applying method steps 100-122.

The third embodiment of the data block identification assigning device 600 causes, similar to the second embodiment, that the data blocks 22 which are assigned to group identification i are compactly stored at the beginning of cache memory 60-65. As the subsequent data blocks 22 are stored in sequence according to the data block identification c. Thus, the locality during access to data blocks 22 not belonging to group identification i, which are held anyway, is improved.

Each end user device 16a-16f, 50-55 is able to decode the files assigned to group i by means of received code symbols (jointly encoded data blocks) and the data blocks 22 held in cache memory 20a-20f, 60-65. The data blocks 22 held in cache memory 20a-20f, 60-65 correspond to a subset of existing code symbols. Reading and writing access are performed by means of a file system device 600.

In order to obtain a system wide data block identification c from a local data block identification d, a further data block identification assigning device 700, as depicted in FIG. 10, may be provided. The data block identification assigning device 700 comprises an identification decoding device 702, a mapping device 704 and an identification encoding device 706. This configuration substantially corresponds to the configuration of data block identification assigning device 600. The mapping device 704 transforms the lists merely based on inverted operations with respect to mapping device 604.

The methods 100-122, 200-218 and the networks 10 as described herein provide an efficient implementation of index coding, which is neither computationally demanding nor memory-intensive. Thus, the methods 100-122, 200-218 and the networks 10 are particularly suitable for realization in conjunction with mobile radio networks.

What is claimed is:

1. An identification encoding device for assigning of an identification to a list of elements for data distribution in a Network, wherein the list of elements has a plurality of elements selected from a set of elements, wherein each element is represented by a whole number, wherein the set of elements has a predetermined total number (N) of elements, wherein the identification encoding device is configured for performing the following:
counting the number of elements of the list of elements and storing the number in a cardinality counter (k);
storing the number 0 in a limiting counter (b);
storing the number 0 in a cache;
storing a smallest element of the list of elements in an element buffer;
removing the smallest element from the list of elements;
comparing the values of the element buffer and the limiting counter (b) and continuing with decrementing the cardinality counter (k) by 1 if the values are identical, else continuing with calculating of binomial coefficient
$$( \begin{matrix}N b 1 \\ k - 1\end{matrix} )$$
and addling the result to the cache;
decrementing the cardinality counter (k) by 1;
comparing the value of the cardinality counter with 0 and continuing with handing over the content of the cache as identification, if the cardinality counter (k) equals 0, else continuing with incrementing the limiting counter (b) by 1;
incrementing (118) of the limiting counter (b) by 1;
determining, whether the limiting counter corresponds to the total number of elements, if yes, continuing with handing over the content of the cache as identification, else continuing with incrementing the limiting counter (b) by 1;
calculating of binomial coefficient
$$( \begin{matrix}N - b - 1 \\ k - 1\end{matrix} )$$
and adding the result to the cache;
incrementing the limiting counter by 1;
comparing the limiting counter (b) with the total number (N) of elements and continuing with handing over the content of the cache as identification, if the values are identical, else continuing with comparing the values of the element buffer and the limiting counter (b) and continuing with decrementing the cardinality counter by 1 if the values are identical, else continuing with calculating of binomial coefficient
$$( \begin{matrix}N - b - 1 \\ k - 1\end{matrix} )$$
and adding the result to the cache,
hand over the content of the cache as identification.

2. An identification decoding device for assigning of a list of elements to an identification for data distribution in a Network, wherein the identification is a whole number and stored in an identification cache, wherein the list of elements has a plurality of elements selected from a set of elements, wherein each element is represented by a whole number, wherein the set of elements has a predetermined total number (N) of elements, wherein the cardinality of the list of elements to be determined is stored in a cardinality counter (k), wherein the identification decoding device is configured for performing the following:
storing the number 0 in a limiting counter (b);
storing the number 0 in an element counter;
storing an empty list as the list of elements;
calculating of binomial coefficient
$$( \begin{matrix}N - b - 1 \\ k - 1\end{matrix} )$$
and storing the calculated binomial coefficient in a buffer;
comparing of the values of the identification cache and of the buffer and continuing in adding the value of the element counter to the list of elements, if the identification cache has a value greater than or equal to the value of the buffer, otherwise continuing with decrementing the value of the identification cache by the value of the buffer;
decrementing of the value of the identification cache by the value of the buffer;
incrementing the limiting counter (b) by 1;
comparing of the value of the limiting counter (b) with the total number (N) and continuing with outputting the list of elements as result, if the values are identical, otherwise continuing with calculating binomial coefficient
$$( \begin{matrix}N - b - 1 \\ k - 1\end{matrix} )$$
and storing the calculated binomial coefficient in a buffer;
outputting of the list of elements as a result;
adding the value of the element counter to the list of elements;
incrementing of the list of elements by 1;
decrementing of the cardinality counter (k) by 1;
comparing the value of the cardinality counter (k) with 0 and continuing outputting of the list of elements as a result, if this is the case, otherwise continuing with incrementing the limiting counter by 1.

3. A cache assigning device for assigning data blocks to end user devices in a network, the data blocks being part of a file from a data library, respectively, wherein the cache assigning device is given a number of group identifications, a system parameter, a group identification, a data block identification, and a file identification as input data, wherein the cache assigning device comprises an identification decoding device according to claim 2 by means of which a list of elements may be generated from the number, the system parameter which corresponds to a cardinality counter, and the data block identification, the list of elements containing group identifications, whose end user devices belonging to the same are to cache a data block which is identifiable by the data block identification, wherein the cache assigning device is configured for generating a cache signal, if the group identification is included in the list of elements and wherein the cache assigning device is configured for generating a non-cache signal, if the group identification is not included in the list of elements.

4. A group encoding device for determining a list of jointly encodable requests from a list of waiting requests, wherein each request comprises at least one group identification (i) and a data block identification (c), wherein the group encoding device comprises for the purpose of processing a selected request (c, i):
an identification decoding device for determining a list of group identifications (i), in whose assigned cache memories the data block having the requested identification (c) is held;
a candidate determining device for determining a list of all group identifications (i′) and lists, which result from removing a group identification (i′) from the list and inserting the group identification (i) of the selected request into the list;
an identification encoding device for determining a list of group identifications (i′) and data block identifications (c′) from the list, wherein the identification encoding device assigns an identification (c′) to each List from the list, wherein the identification encoding device performs the assigning corresponding to the identification encoding device of claim 1; and
a request selecting device for determining a list by means of combining the list and the list of waiting requests such that for each entry (i′, c′) of the list at most one entry of the list of form (i, f, c) is selected for adding to the list such that i′=i and c′=c.

5. A communication device for transforming information about a jointly encoded data block into header data, wherein the communication device is given a list of group identifications, a list of file identifications, and a system parameter as information about the data block, wherein the communication device comprises an identification encoding device according to claim 1 for transforming the list of group identifications into an index, and a header data generating device for cooperatively transforming the index and the list of file identifications into header data.

6. A file system device for assigning a local data block identification to a data block identification, comprising an identification decoding device according to claim 2 for generating a list of group identifications of groups holding the data block designated by the data block identification, and a mapping device for transforming the list.

7. A file system device for determining a data block identification belonging to a local data block identification, comprising an identification decoding device according to claim 2 for generating a list of group identifications, and a mapping device for transforming the list.

8. A method for assigning an identification to a list of elements for data distribution in a network, wherein the list of elements has a plurality of elements selected from a set of elements, wherein each element is represented by a whole number, wherein the set of elements has a predetermined total number (N) of elements, and the method comprising:
counting the number of elements of the list of elements and storing the number in a cardinality counter (k);
storing the number 0 in a limiting counter (b);
storing the number 0 in a cache;
storing of the smallest element of the list of elements in an element buffer;
removing of the smallest element from the list of elements;
comparing the values of the element buffer and the limiting counter (b) and continuing decrementing the cardinality counter (k) by 1, if the values are identical, else continuing calculating of binomial coefficient
$$( \begin{matrix}N - b - 1 \\ k - 1\end{matrix} )$$
and adding the result to the cache;
decrementing the cardinality counter (k) by 1;
comparing the value of the cardinality counter (k) with 0 and continuing with handing over the content of the cache as identification, if the cardinality counter (k) equals 0, else continuing with incrementing of the limiting counter (b) by 1;
incrementing of the limiting counter (b) by 1;
determining, whether the limiting counter (b) corresponds to the total number (N) of elements, if yes, continuing with handing over the content of the cache as identification, else continuing with incrementing of the limiting counter (b) by 1;
calculating of binomial coefficient
$$( \begin{matrix}N - b - 1 \\ k - 1\end{matrix} )$$
and adding the result to the cache;
incrementing of the limiting counter (b) by 1;
comparing the limiting counter (b) with the total number (N) of elements and continuing with handing over the content of the cache as identification, if the values are identical, else continuing with comparing the values of the element buffer and the limiting counter (b) and continuing decrementing the cardinality counter (k) by 1, if the values are identical, else continuing calculating of binomial coefficient
$$( \begin{matrix}N - b - 1 \\ k - 1\end{matrix} )$$
and adding the result to the cache; and
hand over the content of the cache as identification.

9. The method according to claim 8, further comprising at least one of:
calculating an association table, which, depending on the total number of elements (N) and the cardinality (k) of the list of elements, comprises pre-calculated binomial coefficients for using the same in calculating the binomial coefficient; and
in calculating the binomial coefficient, determining the binomial coefficient based on the association table instead of calculation of the binomial coefficient.

10. The method for assigning a list of elements to an identification for data distribution in a network, wherein the identification is a whole number and stored in an identification cache, wherein the list of elements has a plurality of elements selected from a set of elements, wherein each element is represented by a whole number, wherein the set of elements has a predetermined total number (N) of elements, wherein the cardinality of the list of elements to be determined is stored in a cardinality counter (k), and the method comprising:
storing the number 0 in a limiting counter (b);
storing the number 0 in an element counter;
storing an empty list as the list of elements;
calculating of binomial coefficient
$$( \begin{matrix}N - b - 1 \\ k - 1\end{matrix} )$$
and storing the calculated binomial coefficient in a buffer;
comparing of the values of the identification cache and of the buffer and continuing adding the value of the element counter to the list of elements, if the identification cache has a value greater than or equal to the value of the buffer, otherwise continuing with decrementing of the value of the identification cache by the value of the buffer;
decrementing of the value of the identification cache by the value of the buffer;
incrementing the limiting counter (b) by 1;
comparing of the value of the limiting counter (b) with the total number (N) and continuing with outputting of the list of elements as result, if the values are identical, otherwise continuing with calculating of binomial coefficient
$$( \begin{matrix}N - b - 1 \\ k - 1\end{matrix} )$$
and storing the calculated binomial coefficient in a buffer;
outputting of the list of elements as result;
adding the value of the element counter to the list of elements;
incrementing of the list of elements by 1;
decrementing of the cardinality counter (k) by 1; and
comparing the value of the cardinality counter (k) with 0 and continuing in outputting of the list of elements as a result, if this is the case, otherwise continuing with incrementing the limiting counter (b) by 1.

11. The method according to claim 10, the method further comprising at least one of:
calculating an association table, which, depending on the total number of elements (N) and the cardinality (k) of the list of elements, comprises pre-calculated binomial coefficients for using the same in calculating the binomial coefficient; and
in calculating the binomial coefficient, determining the binomial coefficient based on the association table instead of calculation of the binomial coefficient.

12. A network for distributing data to end user devices in the network, wherein elements of data can be cached in a cache memory of the end user devices, wherein each element is identifiable by a whole number, and at least one end user device comprises an assigning device configured for performing the method according to claim 8.

13. A network for distributing data to end user devices in the network, wherein elements of data can be cached in a cache memory of the end user devices, wherein each element is identifiable by a whole number, and the network is connected to a server, comprising an assigning device configured for performing the method according to claim 8.

14. A network for distributing data to end user devices in the network, wherein elements of data can be cached in a cache memory of the end user devices, wherein each element is identifiable by a whole number, and at least one end user device comprises an assigning device configured for performing the method according to claim 9.

15. A network for distributing data to end user devices in the network, wherein elements of data can be cached in a cache memory of the end user devices, wherein each element is identifiable by a whole number, and the network is connected to a server, comprising an assigning device configured for performing the method according to claim 9.

16. A network for distributing data to end user devices in the network, wherein elements of data can be cached in a cache memory of the end user devices, wherein each element is identifiable by a whole number, and at least one end user device comprises an assigning device configured for performing the method according to claim 10.

17. A network for distributing data to end user devices in the network, wherein elements of data can be cached in a cache memory of the end user devices, wherein each element is identifiable by a whole number, and the network is connected to a server, comprising an assigning device configured for performing the method according to claim 10.

18. A network for distributing data to end user devices in the network, wherein elements of data can be cached in a cache memory of the end user devices, wherein each element is identifiable by a whole number, and at least one end user device comprises an assigning device configured for performing the method according to claim 11.

19. A network for distributing data to end user devices in the network, wherein elements of data can be cached in a cache memory of the end user devices, wherein each element is identifiable by a whole number, and the network is connected to a server, comprising an assigning device configured for performing the method according to claim 11.

20. A file system device for assigning a local data block identification to a data block identification, comprising an identification decoding device for generating a list of group identifications of groups holding the data block designated by the data block identification, a mapping device for transforming the list, and an identification encoding device according to claim 1 for obtaining the local data block identification from the transformed list.
